(19) United States
(12) Patent Application Publication
(10) Pub. No.: US 2015/0261857 A1
(43) Pub. Date: Sep. 17, 2015

(54) Method And Device For Accessing Websites Via Keywords

(71) Applicant: TENCENT TECHNOLOGY (SHENZHEN) COMPANY LIMITED, Shenzhen City (CN)

(72) Inventor: Daxin ZHOU, Shenzhen (CN)

(21) Appl. No.: 14/723,771

(22) Filed: May 28, 2015

Related U.S. Application Data
(63) Continuation of application No. PCT/CN2013/088277, filed on Dec. 2, 2013.

(30) Foreign Application Priority Data
Dec. 4, 2012 (CN) 2012105126469

(51) Int. Cl. G06F 17/30; H04L 29/08; G06F 17/22

(52) U.S. Cl. CPC G06F 17/30861; G06F 17/2235; H04L 67/02

(57) ABSTRACT

A method and device for accessing websites via keywords is described. After obtaining at least one keyword in an input box, obtaining webpage address record information, which includes website names and link addresses corresponding to the website names. The method includes searching for website names corresponding to the at least one keyword in the webpage address record information, and obtaining link addresses corresponding to the website names which correspond to the at least one keyword. The method includes displaying the link addresses corresponding to the website names which correspond to the at least one keyword in an information prompt bar of the input box.

### CROSS-REFERENCE TO RELATED APPLICATIONS

This application is a continuation of International Application No. PCT/CN2013/088277, filed Dec. 2, 2013. This application claims the benefit and priority of Chinese Application No. 201210512646.9, filed Dec. 4, 2012. The entire disclosures of each of the above applications are incorporated herein by reference.

### FIELD

The present disclosure relates to a method and device for accessing websites via keywords.

### BACKGROUND

This section provides background information related to the present disclosure which is not necessarily prior art.

In the existing Internet technology, domain names of websites are all English strings due to limitations of the domain name system (DNS). Even if a website is a Chinese website (i.e., the website has a Chinese website name, such as the Tencent website, the kaixin website, and so on), users also need to input the corresponding English domain name in the browser address bar so as to access the website.

In typical technique, some browsers integrate search functions in the address bar. A user can obtain a corresponding search page by inputting keywords in an address bar. The search page displays webpage links corresponding to the input keywords and the user can select one of the webpage links to access a corresponding website.

However, the above method for accessing websites via keywords requires the user to first input Chinese keywords and to then perform the operation of selecting webpage links, which hinders the user's operating efficiency, and thus, the above method for accessing websites via keywords lacks operating convenience.

### SUMMARY

This section provides a general summary of the disclosure, and is not a comprehensive disclosure of its full scope or all of its features.

According to various embodiments, a method for accessing websites via keywords is provided, which can improve operating convenience.

A method for accessing websites via keywords includes:

obtaining at least one keyword in an input box;

obtaining webpage address record information, which includes website names and link addresses corresponding to the website names;

searching for website names corresponding to the at least one keyword in the webpage address record information and obtaining link addresses corresponding to the website names which correspond to the at least one keyword; and

displaying the link addresses corresponding to the website names, which correspond to the at least one keyword in an information prompt bar of the input box.

According to various embodiments, a device for accessing websites via keywords is provided, which can improve operating convenience.

A device for accessing websites via keywords includes:

a keyword obtaining module configured to obtain at least one keyword in an input box;

a webpage address record obtaining module configured to obtain webpage address record information, which includes website names and link addresses corresponding to the website names;

a link address obtaining module configured to search for website names corresponding to the at least one keyword in the webpage address record information and obtaining link addresses corresponding to the website names which correspond to the at least one keyword; and

a prompt module configured to display the link addresses corresponding to the website names, which correspond to the at least one keyword in an information prompt bar of the input box.

According to various embodiments, a computing device comprising a processor and a memory is provided, wherein the processor and the memory are connected with each other via an internal bus, the memory stores a set of instructions for performing a method for accessing websites via keywords, and the set of instructions direct the processor to perform acts of:

obtaining at least one keyword in an input box, webpage address record information which includes Chinese website names, English website names, and link addresses corresponding to the Chinese website names, and the English website names, respectively;

searching for website names corresponding to the at least one keyword in the webpage address record information and obtaining link addresses corresponding to the website names which correspond to the at least one keyword; and

displaying the website names, which correspond to the at least one keyword and the link addresses corresponding to the website names, which correspond to the at least one keyword in an information prompt bar of the input box.

In the above method and device for accessing websites via keywords by searching for website names corresponding to the at least one keyword as well as link addresses corresponding to the website names which correspond to the at least one keyword in the webpage address record information, and displaying the link addresses corresponding to the website names which correspond to the at least one keyword in the information prompt bar of the input box, the user can obtain a link address of a website corresponding to at least one keyword immediately after the user inputs the at least one keyword; thus, the user does not need to perform the tedious task of browsing and searching in a search page, thereby improving operating convenience.

The website names corresponding to the at least one keyword are obtained from the webpage address record information, rather than obtained by using a search engine to crawl webpages; thus, the response speed may be greatly improved.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of selected embodiments and not all possible implementations, and are not intended to limit the scope of the present disclosure.

FIG. 1 is a flowchart of a method for accessing websites via keywords according to various embodiments;

FIG. 2 shows a displaying effect of an information prompt bar according to various embodiments;

FIG. 3 shows a displaying effect of an information prompt bar according to various embodiments;

FIG. 4 is a diagram of a device for accessing websites via keywords according to various embodiments;

FIG. 5 is a diagram of a device for accessing websites via keywords according to various embodiments;

FIG. 6 is a diagram of a computing device according to various embodiments.

Corresponding reference numerals indicate corresponding parts throughout the several views of the drawings.

### DETAILED DESCRIPTION

Example embodiments will now be described more fully with reference to the accompanying drawings.

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

As shown in FIG. 1, a method for accessing websites via keywords according to various embodiments includes the following.

S102: Obtaining at least one keyword in an input box. According to various embodiments, the input box may be an address bar of a browser or a search bar of the browser. One user can input strings in the input box to input the keyword. Here, the at least one keyword in the input box refers to all keywords in the input box and the number of all keywords in the input box may be one or more than one.

S104: Obtaining webpage address record information, which includes website names and link addresses corresponding to the website names. According to various embodiments, the webpage address record information includes at least one of a browser access record, a bookmark, a favorite, and a webpage address whitelist. The browser access record is a history access record left by a user after accessing webpages with a browser. The bookmark is network address information displayed in a bookmark bar of the browser. The favorite is network address information displayed in a favorite bar of the browser.

When the browser access record, the bookmark, and the favorite store network links, they can extract contents of a <title> label in a webpage corresponding to each network link, take the extracted contents as a website name, and store the website name corresponding to the each network link. The webpage address whitelist is a preconfigured webpage address list, which stores website names and corresponding link addresses. The user can preconfigure a website name defined by the user and a link address in the webpage address whitelist. It should be noted that the browser access record, the bookmark, the favorite, and the webpage address whitelist are all information stored locally in the browser.

According to various embodiments, obtaining webpage address record information may include obtaining webpage address record information according to an order of the browser access record, the bookmark and/or the favorite, and the webpage address whitelist.

S106: Searching for website names corresponding to the at least one keyword in the webpage address record information and obtaining link addresses corresponding to the website names, which correspond to the at least one keyword. According to various embodiments, first searching for website names corresponding to the at least one keyword in the browser access record is performed. If no website name corresponding to the at least one keyword is found in the browser access record, continuing to search for website names corresponding to the at least one keyword in the bookmark and/or the favorite is performed. If no website name corresponding to the at least one keyword is found in the bookmark and/or the favorite, continuing to search for website names corresponding to the at least one keyword in the webpage address whitelist is performed.

According to various embodiments, searching for website names corresponding to the at least one keyword in the webpage address record information may include searching for website names each containing the at least one keyword in the webpage address record information.

According to various embodiments, S106 may include obtaining string information corresponding to the at least one keyword and string information corresponding to a website name. Judging whether the string information corresponding to the at least one keyword is a continuous substring of the string information corresponding to the website name. If the string information corresponding to the at least one keyword is a continuous substring of the string information corresponding to the website name, the website name matches with the at least one keyword. Step S106 may further include obtaining a link address corresponding to the website name.

For example, a string function indexOf function may be called for the string information corresponding to the website name. If the return is −1, the string information corresponding to the at least one keyword is not a continuous substring of the string information corresponding to the website name. That is, the website name does not contain the at least one keyword; otherwise, the website name contains the at least one keyword.

Further, in this example, before searching for website names corresponding to the at least one keyword in the webpage address record information, the method may further include judging whether the at least one keyword is Chinese. If the at least one keyword is Chinese, searching for website names corresponding to the at least one keyword in the webpage address record information continues.

For example, the judging whether the at least one keyword is Chinese may include obtaining string information of the at least one keyword, obtaining encoding information corresponding to the string information, and judging whether the at least one keyword is Chinese according to the encoding information.

In this example, if the at least one keyword is English, Step S106 may include obtaining Pinyin information corresponding to a website name, obtaining string information corresponding to the Pinyin information, and judging whether the string information corresponding to the Pinyin information contains the at least one keyword. If the string information corresponding to the Pinyin information contains the at least one keyword and the website name matches with the at least one keyword, then S106 may further include obtaining a link address corresponding to the website name.

Further, after searching for website names containing the at least one keyword in the webpage address record information, S106 may further include obtaining string lengths of the discovered website names containing the at least one keyword and obtaining a default number of website names by comparing the string lengths.

In this example, the default number of website names with smaller string lengths may be obtained. For example, if the default number is 2, the found website names corresponding to the keywords “ [symbol] ” (which is the Chinese translation of “Tencent”) include “ [symbol] ” (which is the Chinese translation of “Tencent network”), “ [symbol] [symbol] ” (which is the Chinese translation of “Tencent entertainment channel”), “ [symbol] ” (which is the Chinese translation of “Tencent network TV”) and “ [symbol] ” (which is tge Chinese translation of “Tencent Finance”), website names with smaller string lengths obtained by comparing the string lengths can include “ [symbol] ” (which is the Chinese translation of “Tencent network”) and “ [symbol] ” (which is the Chinese translation of “Tencent Finance”).

Obtaining a default number of website names with smaller string lengths can filter the discovered website names. In the website names containing the at least one keyword and simultaneously having smaller string lengths, since information entropy included with the at least one keyword occupies a larger proportion of each of the whole website names, the website names containing the at least one keyword and simultaneously having smaller string lengths have stronger correlations with the at least one keyword. That is, there is a high matching degree between the at least one keyword and the website names containing the at least one keyword and simultaneously having smaller string lengths and, as a result, there is a higher possibility that the website names containing the at least one keyword and simultaneously having smaller string lengths are websites which the user desires to access, thereby improving matching accuracy.

S108: Displaying link addresses corresponding to the website names which correspond to the at least one keyword in an information prompt bar of the input box.

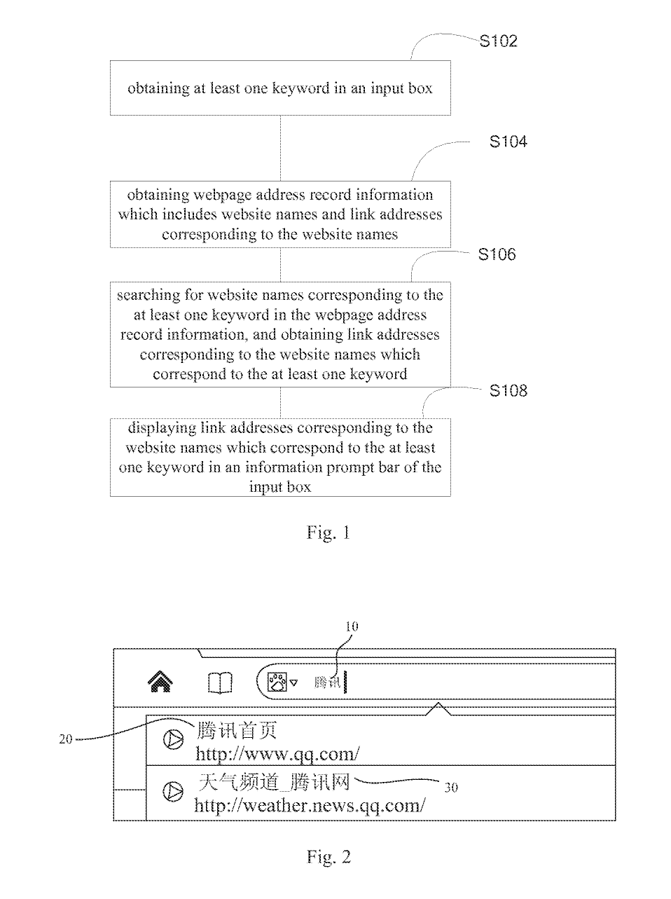

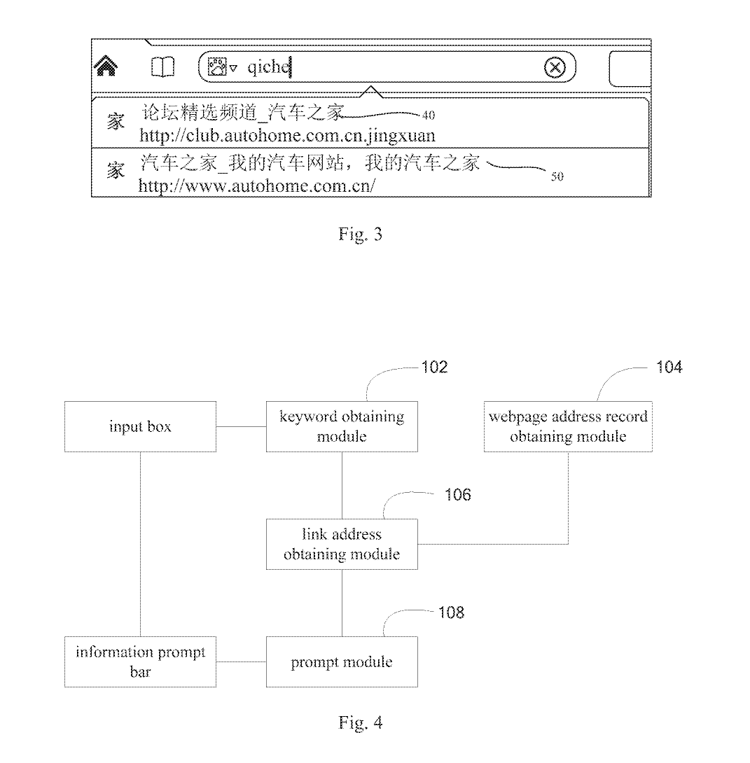

As shown in FIG. 2 and FIG. 3, the input box may be a browser component and the information prompt bar of the input box may be a floating browser information display component, which links up with an edge of the input box or a browser information display component adjacent to the edge of the input box. In this example, the obtained default number of link addresses may be displayed in the information prompt bar in the form of a list. The displayed content may include link addresses and corresponding website names. The user can move a cursor or click on a touch screen to select one of the link addresses for access.

For example, in FIG. 2, if the input keywords are Chinese translations “ [symbol] [symbol] ” 10 (“ [symbol] ” is the Chinese translation of “Tencent”), the link addresses displayed in the information prompt bar corresponds to “ [symbol] ” 20 (“ [symbol] ” is the Chinese translation of “Tencent network”) and “ [symbol] ” 30 (“ [symbol] ” is the Chinese translation of “weather channel_Tencent network”) which contain the string “ [symbol] [symbol] ” 10. In FIG. 3, if the input keywords are Pinyin “qiche”, the link addresses displayed in the information prompt bar corresponds to “ [symbol] [symbol] ” 40 (“ [symbol] [symbol] ” is a Chinese expression of “Forum featured channels_auto home”) and “ [symbol] [symbol] [symbol] ” 50 (“ [symbol] [symbol] [symbol] ” is a Chinese expression of “auto home_my auto website, my auto home”) whose Pinyins include the string “qiche”.

According to various embodiments, before obtaining at least one keyword in an input box, the method may further include detecting whether there is a change in the at least one keyword in the input box. If there is a change in the at least one keyword in the input box, the performance obtaining the at least one keyword in the input box continues.

In this example, whether there is a change in the at least one keyword in the input box may be judged by detecting an onChange event of the input box. The input box is an input component of the browser. When the string information in the input box is changed (for example, when the string information is changed with the user's inputting and deletion), the input box throws an onChange event. After one onChange event is detected, obtaining the at least one keyword in the input box may be performed, thereby obtaining the updated keywords.

For example, if the user wants to access to “ [symbol] ” (which is the Chinese translation of “Tencent network”), the user needs to sequentially input three characters “ [symbol] ” “ [symbol] ” “ [symbol] ” (which are three Chinese characters of “ [symbol] ” which is the Chinese translation of “Tencent network”). When the user inputs the character “ [symbol] ”, the input box throws an onChange event, the onChange event is captured, and it is then obtained that the keyword is “ [symbol] ”. S104, S106, and S108 are performed sequentially. As a result, the information prompt bar of the input bar can display link addresses corresponding to the keyword “ [symbol] ”.

If the candidate link addresses, which are displayed in the information prompt bar and correspond to the keyword “ [symbol] ”, include the link address corresponding to “ [symbol] ”, the user can move a cursor or click on a touch screen to select the link address for access. If the displayed candidate link addresses corresponding to the keyword “ [symbol] ” do not include the link address corresponding to “ [symbol] ”, for example, the displayed candidate link addresses corresponding to the keyword “ [symbol] ” include “ [symbol] ” and “ [symbol] ” (“ [symbol] ” and “ [symbol] ” are exemplary Chinese website names which include the Chinese keyword “ [symbol] ”), the user continues to input the character “ [symbol] ”, the input box continues to throw an onChange event, the onChange event is captured, and it is then obtained that the keyword is “ [symbol] ”. S104, S106, and S108 are performed sequentially. As a result, the information prompt bar of the input bar can display link addresses corresponding to the keywords “ [symbol] ”.

By using the detected change of the keywords in the input box to trigger obtaining the keywords in the input box, the link addresses in the information prompt bar can be updated in real time as the user inputs keywords. This may facilitate the user to select a suitable link address for access and, thus, improve operating convenience.

As shown in FIG. 4, a device for accessing websites via keywords according to various embodiments includes a keyword obtaining module 102, a webpage address record obtaining module 104, a link address obtaining module 106, and a prompt module 108. The keyword obtaining module 102 is configured to obtain at least one keyword in an input box. According to various embodiments, the input box can be an address bar of a browser or a search bar of the browser. A user can input strings in the input box to input the keyword.

The webpage address record obtaining module 104 is configured to obtain webpage address record information, which includes website names and link addresses corresponding to the website names. According to various embodiments, the webpage address record information includes at least one of a browser access record, a bookmark, a favorite, and a webpage address whitelist. The browser access record is a history access record left by a user after accessing webpages with a browser. The bookmark is network address information displayed in a bookmark bar of the browser. The favorite is network address information displayed in a favorite bar of the browser.

When the browser access record, the bookmark, and the favorite store network links, they may extract contents of a <title> label in a webpage corresponding to each network link, take the extracted contents as a website name, and store the website name corresponding to the each network link.

The webpage address whitelist is a preconfigured webpage address list which stores website names and corresponding link addresses. The user can preconfigure a website name defined by the user and a link address in the webpage address whitelist.

The browser access record, the bookmark, the favorite, and the webpage address whitelist are all information stored locally in the browser.

In this example, the webpage address record obtaining module 104 may be configured to obtain webpage address record information according to an order of the browser access record, the bookmark and/or the favorite, and the webpage address whitelist.

The link address obtaining module 106 is configured to search for website names corresponding to the at least one keyword in the webpage address record information and obtain link addresses corresponding to the website names.

In this example, the link address obtaining module 106 can be configured to first search for website names corresponding to the at least one keyword in the browser access record. If no website name corresponding to the at least one keyword is found in the browser access record, searching for website names corresponding to the at least one keyword in the bookmark and/or the favorite continues. If no website name corresponding to the at least one keyword is found in the bookmark and/or the favorite, searching for website names corresponding to the at least one keyword in the webpage address whitelist continues.

According to various embodiments, the link address obtaining module 106 may be configured to search for website names each containing the at least one keyword in the webpage address record information.

In this example, the link address obtaining module 106 can be configured to obtain string information corresponding to the at least one keyword and string information corresponding to a website name and judge whether the string information corresponding to the at least one keyword is a continuous substring of the string information corresponding to the website name. If the string information corresponding to the at least one keyword is a continuous substring of the string information corresponding to the website name and the website name matches with the at least one keyword, then the link address obtaining module 106 may be configured to obtain a link address corresponding to the website name.

For example, the link address obtaining module 106 may be configured to call a string function indexOf function for the string information corresponding to the website name. If the return is −1, the string information corresponding to the at least one keyword is not a continuous substring of the string information corresponding to the website name, that is, the website name does not contain the at least one keyword; otherwise, the website name contains the at least one keyword.

Further, in this example, the device for accessing websites via keywords further includes a Chinese-English judgment module (not shown in the figures), which may be configured to judge whether the at least one keyword is Chinese and, if the at least one keyword is Chinese, call the link address obtaining module 106.

The Chinese-English judgment module may be further configured to obtain string information of the at least one keyword, obtain encoding information corresponding to the string information, and judge whether the at least one keyword is Chinese according to the encoding information.

In this example, if the at least one keyword is English, the link address obtaining module 106 may be further configured to obtain Pinyin information corresponding to a website name, obtain string information corresponding to the Pinyin information, and judge whether the string information corresponding to the Pinyin information contains the at least one keyword. If the string information corresponding to the Pinyin information contains the at least one keyword and the website name matches with the at least one keyword, then the link address obtaining module 106 can be further configured to obtain a link address corresponding to the website name.

Further, the link address obtaining module 106 may be further configured to obtain string lengths of the found website names containing the at least one keyword and obtain a default number of website names by comparing the string lengths.

In this example, the link address obtaining module 106 may be further configured to obtain the default number of website names with smaller string lengths. For example, if the default number is 2, the found website names corresponding to the keywords “ [symbol] ” (which is the Chinese translation of “Tencent”) include “ [symbol] ” (which is the Chinese translation of “Tencent network”), “ [symbol] ” (which is the Chinese translation of “Tencent entertainment channel”), “ [symbol] ” (which is the Chinese translation of “Tencent network TV”) and “ [symbol] ” (which is the Chinese translation of “Tencent Finance”), website names with smaller string lengths obtained by comparing the string lengths can include “ [symbol] ” (which is the Chinese translation of “Tencent network”) and “ [symbol] ” (which is the Chinese translation of “Tencent Finance”).

Obtaining a default number of website names with smaller string lengths can filter the found website names. In the website names containing the at least one keyword and simultaneously having smaller string lengths, since information entropy included with the at least one keyword occupies a larger proportion of each of the whole website names, the website names containing the at least one keyword and simultaneously having smaller string lengths have stronger correlations with the at least one keyword. That is, there is a high matching degree between the at least one keyword and the website names containing the at least one keyword and simultaneously having smaller string lengths and, as a result, there is a higher possibility that the website names containing the at least one keyword and simultaneously having smaller string lengths are websites which the user desires to access, thereby improving matching accuracy.

The prompt module 108 may be configured to display link addresses in an information prompt bar of the input box.

As shown in FIG. 2 and FIG. 3, the input box can be a browser component and the information prompt bar of the input box can be a floating browser information display component which links up with an edge of the input box or a browser information display component adjacent to the edge of the input box. In this example, the prompt module 108 may be configured to display the obtained default number of link addresses in the information prompt bar in the form of a list. The displayed content may include link addresses and corresponding website names. The user may move a cursor or click on a touch screen to select one of the link addresses for access.

For example, in FIG. 2, if the input keywords are Chinese terms “ [symbol] ” 10 (“ [symbol] ” is the Chinese translation of “Tencent”), the link addresses displayed in the information prompt bar corresponds to “ [symbol] ” 20 (“ [symbol] ” is the Chinese translation of “Tencent network”) and “ [symbol] ” 30 (“ [symbol] ” is the Chinese translation of “Tencent Finance”) which contain the string “ [symbol] ” 10. In FIG. 3, if the input keywords are Pinyin “qiche”, the link addresses displayed in the information prompt bar correspond to “ [symbol] [symbol] ” 40 (“ [symbol] [symbol] ” is the Chinese expression of “Forum featured channels_auto home”) and “ [symbol] [symbol] [symbol] ” 50 (“ [symbol] [symbol] , [symbol] ” is the Chinese translation of “auto home_my auto website, my auto home”) whose Pinyins include the string “qiche”.

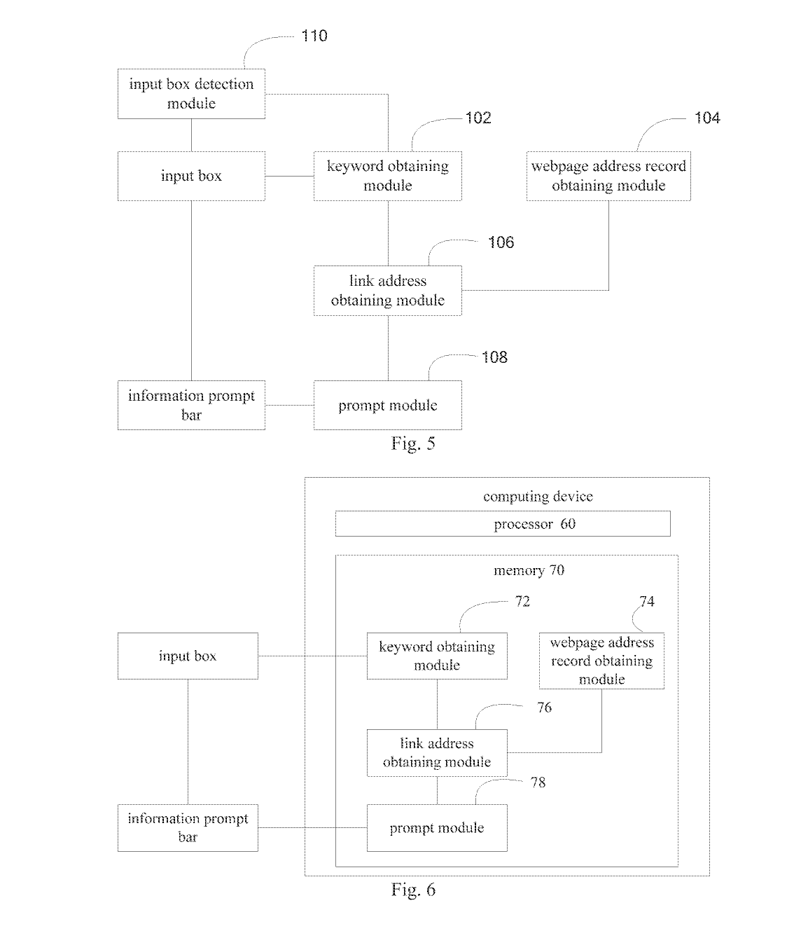

According to various embodiments, as shown in FIG. 5, the device for accessing websites via keywords further includes an input box detection module 110, which can be configured to detect whether there is a change in the at least one keyword in the input box. If there is a change in the at least one keyword in the input box, the input box detection module 110 can be further configured to call the keyword obtaining module 102.

In this example, the input box detection module 110 can be further configured to judge whether there is a change in the at least one keyword in the input box by detecting an onChange event of the input box. The input box is an input component of the browser. When the string information in the input box is changed (for example, when the string information is changed with the user's inputting and deletion), the input box throws an onChange event. After one onChange event is detected, the at least one keyword in the input box can be obtained, thereby obtaining the updated keywords.

For example, if the user wants to access to “ [symbol] ” (which is the Chinese translation of “Tencent network”), the user needs to sequentially input three characters “ [symbol] ” “ [symbol] ” “ [symbol] ” (which are three Chinese characters of “ [symbol] ” which is the Chinese translation of “Tencent network”). When the user inputs the character “ [symbol] ”, the input box throws an onChange event, the onChange event is captured, and it is then ascertained that the keyword is “ [symbol] ”. S104, S106, and S108 are then performed sequentially. As a result, the information prompt bar of the input bar can display link addresses corresponding to the keyword “ [symbol] ”.

If the candidate link addresses, which are displayed in the information prompt bar and corresponding to the keyword “ [symbol] ”, include the link address corresponding to “ [symbol] ”, the user can move a cursor or click on a touch screen to select the link address for access. If the displayed candidate link addresses corresponding to the keyword “ [symbol] ” does not include the link address corresponding to “ [symbol] ”, for example, the displayed candidate link addresses corresponding to the keyword “ [symbol] ” includes “ [symbol] ” and “ [symbol] ” (“ [symbol] ” and “ [symbol] ” are exemplary Chinese website names which include the Chinese keyword “ [symbol] ”), the user continues to input the character “ [symbol] ”, the input box continues to throw an onChange event, the onChange event is captured and then it is obtained that the keyword is “ [symbol] ”. S104, S106, and S108 are then performed sequentially. As a result, the information prompt bar of the input bar can display link addresses corresponding to the keywords “ [symbol] ”.

By using the detected change of the keywords in the input box to trigger obtaining the keywords in the input box, the link addresses in the information prompt bar may be updated in real time as the user inputs keywords. This can facilitate the user to select a suitable link address for access and, thus, improve operating convenience.

In the above method and device for accessing websites via keywords by searching for website names corresponding to the at least one keyword, as well as link addresses corresponding to the website names which correspond to the at least one keyword in the webpage address record information and displaying the link addresses corresponding to the website names which correspond to the at least one keyword in the information prompt bar of the input box, the user can obtain a link address of a website corresponding to at least one keyword immediately after the user inputs the at least one keyword. Thus, the user does not need to perform the tedious task of browsing and searching in a search page, thereby improving operating convenience.

The website names corresponding to the at least one keyword are obtained from the webpage address record information rather than obtained by using a search engine to crawl webpages and, thus, the response speed may be greatly improved.

The above device can run in a computing device shown in FIG. 6. As shown in FIG. 6, the computing device (such as a computer or other computing device) includes a processor 60 and a memory 70. The processor 60 and the memory 70 are connected with each other via an internal bus. The memory 70 may be a non-transitory computer-readable storage medium and stores units of machine readable instructions executable by the processor 60, including a keyword obtaining module 72, a webpage address record obtaining module 74, a link address obtaining module 76, and a prompt module 78. Functions of the keyword obtaining module 72, the webpage address record obtaining module 74, the link address obtaining module 76, and the prompt module 78 are similar with the functions of the keyword obtaining module 102, the webpage address record obtaining module 104, the link address obtaining module 106, and the prompt module 108, respectively. The functions may be implemented with the assistance of other modules and may involve cooperation of multiple modules, e.g., may utilize processing functions of the processor 60, may relay on the internal bus for data transmission, and etc.

The methods, module, and device described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. Specifically, a system or apparatus having a storage medium that stores machine-readable program codes for implementing functions of any of the above examples and that may cause the system or the apparatus (or processor such as CPU or MPU) read and execute the program codes stored in the storage medium.

In this situation, the program codes read from the storage medium may implement any one of the above examples, thus, the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration and are not meant as limitations. Many variations are possible within the spirit and scope of the subject matter, which is intended to be defined by the following claims—and their equivalents—in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for accessing websites via keywords comprising:
obtaining at least one keyword in an input box;
obtaining webpage address record information which includes website names and link addresses corresponding to the website names;
searching for website names corresponding to the at least one keyword in the webpage address record information, and obtaining link addresses corresponding to the website names which correspond to the at least one keyword;
displaying the link addresses corresponding to the website names which correspond to the at least one keyword in an information prompt bar of the input box.

2. The method of claim 1, wherein the webpage address record information comprises at least one of a browser access record, a bookmark, a favorite and a webpage address whitelist.

3. The method of claim 2, wherein the obtaining webpage address record information comprises:
obtaining the webpage address record information according to an order of the browser access record, the bookmark and/or the favorite, and the webpage address whitelist.

4. The method of claim 1, wherein the searching for website names corresponding to the at least one keyword in the webpage address record information comprises:
searching for website names each containing the at least one keyword in the webpage address record information.

5. The method of claim 4, wherein after the searching for website names each containing the at least one keyword in the webpage address record information, the method further comprises:
obtaining string lengths of found website names containing the at least one keyword; and
obtaining a default number of website names containing the at least one keyword by comparing the string lengths.

6. The method of claim 1, wherein before the obtaining at least one keyword in an input box, the method further comprises:
detecting whether there is a change in the at least one keyword in the input box; if there is a change in the at least one keyword in the input box, continue to obtain at least one keyword in the input box.

7. The method of claim 1, wherein the webpage address record information includes Chinese website names, English website names, and link addresses corresponding to the Chinese website names and the English website names website names, respectively.

8. A device for accessing websites via keywords comprising:
a keyword obtaining module configured to obtain at least one keyword in an input box;
a webpage address record obtaining module configured to obtain webpage address record information which includes website names and link addresses corresponding to the website names;
a link address obtaining module configured to search for website names corresponding to the at least one keyword in the webpage address record information, and obtaining link addresses corresponding to the website names which correspond to the at least one keyword;
a prompt module configured to display the link addresses corresponding to the website names which correspond to the at least one keyword in an information prompt bar of the input box.

9. The device of claim 8, wherein the webpage address record information comprises at least one of a browser access record, a bookmark, a favorite and a webpage address whitelist.

10. The device of claim 9, wherein the webpage address record obtaining module is further configured to obtain the webpage address record information according to an order of the browser access record, the bookmark and/or the favorite, and the webpage address whitelist.

11. The device of claim 8, wherein the link address obtaining module is further configured to search for website names each containing the at least one keyword in the webpage address record information.

12. The device of claim 11, wherein the link address obtaining module is further configured to obtain string lengths of found website names containing the at least one keyword and obtain a default number of website names containing the at least one keyword by comparing the string lengths.

13. The device of claim 8, wherein the device further comprises:
an input box detection module which is configured to detect whether there is a change in the at least one keyword in the input box; if there is a change in the at least one keyword in the input box, call the keyword obtaining module.

14. The device of claim 8, wherein the webpage address record information includes Chinese website names, English website names, and link addresses corresponding to the Chinese website names and the English website names website names, respectively.

15. A computing device comprising a processor and a memory; wherein the processor and the memory are connected with each other via an internal bus; the memory stores a set of instructions for performing a method for accessing websites via keywords, the set of instructions to direct the processor to perform acts of:
obtaining at least one keyword in an input box, webpage address record information which includes Chinese website names, English website names, and link addresses corresponding to the Chinese website names and the English website names, respectively;
searching for website names corresponding to the at least one keyword in the webpage address record information, and obtaining link addresses corresponding to the website names which correspond to the at least one keyword;
displaying the website names which correspond to the at least one keyword and the link addresses corresponding to the website names which correspond to the at least one keyword in an information prompt bar of the input box.
